(19) United States
(12) Patent Application Publication
(10) Pub. No.: US 2003/0015877 A1
(43) Pub. Date: Jan. 23, 2003

(54) Wind power plant

(76) Inventor: Alfred Schlemenat, Herten (DE)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/196,612

(22) Filed: Jul. 16, 2002

(30) Foreign Application Priority Data
Jul. 17, 2001 (DE) 101 34 829.0
Aug. 25, 2001 (DE) 101 41 733.0

(51) Int. Cl. F03D 9/00; H02P 9/04

(52) U.S. Cl. 290/55

(57) ABSTRACT

The invention relates to a wind power plant with a tower (2), with a rotor shaft (7) rotating in a gondola (5), and with rotor blades (8) on which wind forces act on the rotor shaft (7). It is characterized in that a carrying structure (10) disposed on the underside of the gondola (5) extends inside the tower (2) vertically relative to the fastening point (1) and is connected with the gondola (5) so as to be rotation-proof and torsion-proof relative to the gondola and forming a functional unit (11) with the gondola. In order to improve the dynamic carrying behavior, components for converting the mechanical energy into another form of energy, a plurality of generators (15′), for example, are disposed on the carrying structure (10). The rotor shaft (7) extends from the windward side to the leeward side. The gondola (5) is provided with conventional and cost-effective bearings (12, 12′) on the windward and leeward sides. An optimal flux of force is achieved. The bearing forces are transmitted directly into the tower. The rotor hub (9) is disposed both on the windward or the leeward side, and on the windward and the leeward side.

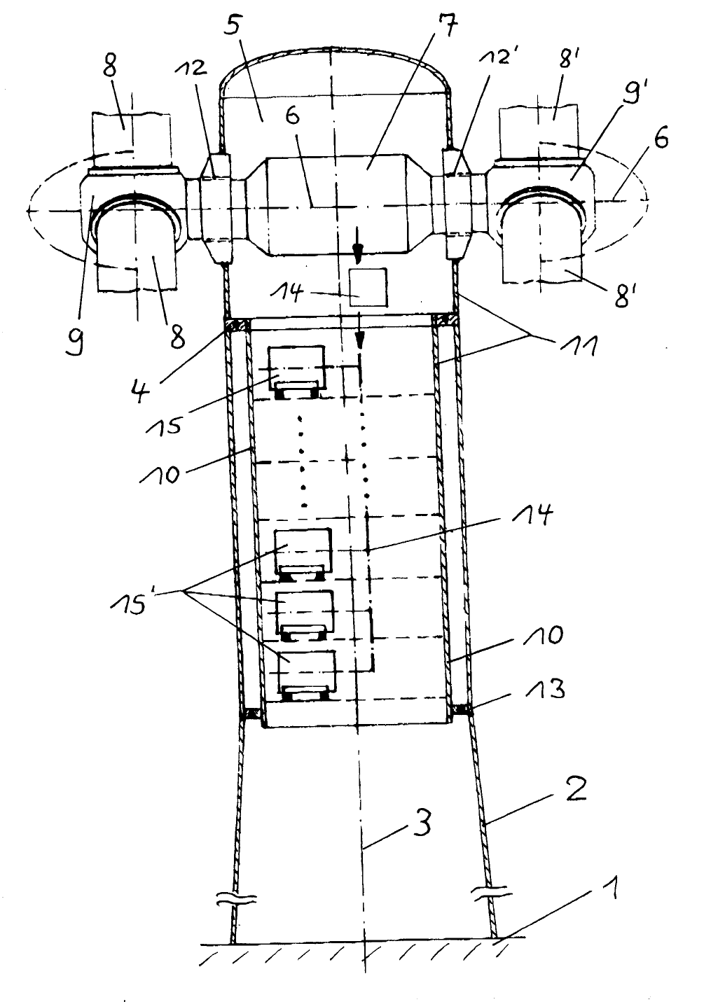

### STATEMENT REGARDING FEDERALLY SPONSORED RESEARCH OR DEVELOPMENT

Not Applicable.

### CROSS-REFERENCE TO RELATED APPLICATIONS

This application claims priority to German Application Nos. DE 101 34 829.0 filed Jul. 17, 2001 and DE 101 41 733.0 filed Aug. 25, 2001.

### BACKGROUND OF THE INVENTION

The invention relates to a wind power plant of the type having a gondola mounted on a tower and having blades mounted therein to be rotated by wind and which converts the mechanical energy of rotating blades into another form of energy. Such wind power plants are state of the art. A person skilled in the art is familiar with the interaction of the primary components for using the flow energy of the wind. It is described, for example, in the German technical books entitled “Wind Power Plants”, Erich Hau, Springer Verlag [publishing house] (1988) and (1996, 2^{nd} Edition).

In the known wind power plants, the connection principle for the tower-gondola connections is virtually identical because of the requirements specified by the bearing manufacturers. They require periodic inspections of the screw preloading forces on the fastening screws for the bearing, so that free access to the screws must be ensured. Therefore, in the known wind power plants the required primary components for converting the mechanical energy of the rotor shaft into another form of energy are disposed above the tower-gondola connection in the gondola. With regard to the natural vibration behavior, however, they are at an unfavorable distance from the tower fastening point, which has a negative effect on the dynamic carrying behavior of a system.

The tower segments are connected by means of preloaded screws, which are particularly highly susceptible to fatigue fracture because of the changeable effect of the wind. Loose screws are frequently found, although they were designed with the greatest care. They should be considered triggers of unexplainable bearing and gearing damage.

The above is confirmed by damage frequently reported in recent times. According to a topical literature reference, Marcus Jansen: “Study of Dynamic Loads on the Power Train”, Renewable Energies July 2001, page 36 ff (SunMedia Verlag, Hannover) the recent damage on bearings and gearing is caused by an inadequate allowance for the dynamic stresses when wind power plants are dimensioned. The findings based on logical conclusions, that weight reductions at the top of a system will lead to a decrease in all dynamic stresses acting on the tower are of limited use for the known wind power plants because of the above described tower-gondola connections.

Also, objections from the population in the approval processes make it more difficult to build new plants. This will increasingly lead to an efficient use of the existing locations. However, new plants with a higher capacity can rarely be built on the foundations of older or outdated plants.

The aim of the invention is to improve the dynamic carrying and natural vibration behavior of a wind power plant such that the above described damages are minimized or prevented, that the stresses on foundations caused by dynamic loads are reduced, especially for new plants of a higher capacity classification, and that new more powerful plants can be built on existing foundations.

### BRIEF SUMMARY OF THE INVENTION

The problem is solved in accordance with the invention by providing a carrying structure disposed on the underside of the gondola and which extends inside the tower vertically relative to the fastening point. The carrying structure carries components for converting the mechanical energy into a different form of energy are disposed and is connected with the gondola in rotation-proof and torsion-proof manner to form a functional unit. This allows for the rotor shaft to be lengthened inside the gondola so that it extends from the windward side to the leeward side.

On the underside of the gondola, a carrying structure projecting into the tower is connected with the gondola so as to be rotation-proof and torsion-proof. The gondola and the carrying structure form a functional unit. The primary components for converting the mechanical energy into another form of energy are no longer disposed in the gondola, but decisively closer to the foot or connecting point of the tower. By shifting the components out of the gondola, the components are at a favorable distance from the tower fastening point and lead to an improvement in the natural vibration behavior of the complete system. The carrying behavior suggests a cylindrical design for the carrying structure. The functional unit is positioned so as to rotate about the tower's longitudinal axis by means of a bearing which is rigged on the tower with the carrying structure or according to the common method with the gondola. The rigging of the bearing, however, is achieved with a new connection system as defined in EP 1 010 931, which is incorporated herein by reference. In this system, screws do not transmit the forces and moments, so that screw relaxation and material fatigue do not occur. The periodic inspections of the screw preloading forces which are mandatory for the known wind power plants are no longer necessary. This results in a covered arrangement and maintenance-free rigging of the bearing. Another bearing in the bottom area of the carrying structure transmits horizontal forces directly into the tower and leads to a considerable reduction in the bending stresses on the bearing for the functional unit/tower.

Unlike the gondola designs in the known wind power plants, a gondola, which is substantially smaller in terms of spatial dimensions and with a more favorable weight, can be used. It is advantageously configured as a cylindrical extension of the tower structure.

The free space in the gondola is used for lengthening the rotor shaft from the windward side to the leeward side. The large bearing space leads to the desired favorable natural vibration behavior of the rotor shaft and to the use of conventional and cost-effective bearings. The bearing forces are easily managed. For receiving the bearings, relatively thick-walled loose flanges, such as those commonly used in high-pressure apparatus engineering and representing the state of the art, are welded directly into the cylinder bowl. This results in an optimal flux of force. All forces are guided via the gondola wall directly into the tower wall.

In the known systems, the energy supply from the air flow at high wind intensities often exceeds the rate acceptable by a generator. Excess capacity is frequently not utilized. The arrangement of multiple generators of the reliable smaller capacity categories closer to the tower foundation, on the other hand, results in an optimal use of the energy supply, and thus in an increase in the operating range of a system. Based on the wind velocity, one generator or an appropriate number of generators is activated. In addition to the desired improvement in the dynamic carrying behavior of the system, other advantages are achieved. For example, an outside crane is no longer necessary because the relatively small components can be mounted and replaced for repair from the inside of the tower. This is especially cost-effective for large plants used offshore.

In addition to the rotor hub on the windward or leeward side, a second rotor hub should be disposed on the opposite free end of the rotor shaft. In order to effectively utilize the flow energy of the wind, the arrangement, the design and the position of the rotor blades relative to each other are determined based on aerodynamic optimization. The rotor blades are aligned in rotating direction of the rotor shaft permanently fixed or variable in dependence of the rotor speed relative to each other so that the angular position relative to the rotating direction of the axis of rotation ensures an optimal transmission of the energy to the two rotor hubs. The relatively high ratio of the rotor blade diameter to the axial extension of the rotor blades on the windward and leeward sides prevents the rotor blades disposed on the leeward side from being affected by air eddies.

Any effects from tower back-up and tower shading can be minimized by means of optimizing the influencing lengths of the shaft ends due to the relatively large bearing space.

The desirable identical carrying forces of the two rotor hubs have a favorable effect on the rotational vibration of the rotor shaft. Compared to the known systems, twice the number of rotor blade arrangements will halve the forces and moments on the rotor blade connection. On the other hand, with the same stresses on the rotor hub, the output to be transmitted to the rotor shaft can be doubled, for example by lengthening the blade length.

The rotation energy of the rotor shaft is transmitted to the components disposed at a vertical distance closer to the foot of the tower by means of an active connection. This active connection consists of standard components, for example mechanically or hydraulically acting gearings, shafts or other power transmission elements. These elements are disposed separately, multiply or in combination depending on the structural circumstances. The length of the carrying structure projecting into the tower decisively affects the dynamic stresses of the complete system, but it equally increases the vertical distance for transmitting the mechanical energy. Therefore, the advantages to be achieved must be in economic relation with the manufacturing costs.

Especially in the plants of the higher capacity categories with large tower diameters, the components and additional ballast weights, if applicable, are disposed at the largest structurally achievable distance from the center of the tower on the windward side of the carrying structure. Their mass with the lever arm generates a moment toward the tower center axis which counteracts the wind moment and leads to a reduction in the bending stresses on the foundation. Moreover, with increasing plant size, the component weights of the required equipment for orienting the top of the tower according to the wind direction increase enormously. According to this invention, the components, including the fastening system, are disposed in the bottom area of the carrying structure and act with a highly reduced lever arm on the tower fastening. This also has a positive effect on the dynamic carrying behavior of the complete system. Because an arrangement of the rotor hub on the leeward side is stable for physical reasons with regard to the wind direction orientation, a rotor hub on the windward and leeward side causes an almost theoretical balance of forces and results in relatively low component weights and therefore in cost-effective equipment for orienting and fastening the gondola.

### BRIEF DESCRIPTION OF THE SEVERAL VIEWS OF THE DRAWINGS

The Drawing is a schematic sectional view of a wind power plant of the present invention

Corresponding reference numerals will be used throughout the several figures of the drawings.

### DETAILED DESCRIPTION OF THE INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

The schematic sectional view shows the wind power plant of the invention with a cylindrical tower 2 and a gondola 5 from which a carrying structure 10 depends. The carrying structure 10 is also cylindrical. The carrying structure 10 projects into the tower 2 and is connected to the gondola so as to be rotation-proof and torsion-proof. The gondola 5 and the carrying structure 10 form a functional unit 11, which is rigged with the tower 2 via a bearing 4 to be able to rotate about the tower longitudinal axis 3. The bearing is rigged by means of a connecting system as defined in EP 1 010 931, which is incorporated herein by reference. Screws do not transmit any forces and moments. Details of the connecting system are not shown. At the bottom side of the carrying structure 10, between the carrying structure and the tower 2, another bearing 13 is disposed. The bearing 13 transmits horizontal forces from the carrying structure 10 directly to the tower 2. The bearing 4 is relieved of the bending stresses. On the carrying structure a plurality of generators 15, 15′ are shown diagrammatically.

The gondola 5 is configured as a cylindrical extension of the cylindrical tower 2. The rotor shaft 7 extends inside the gondola 5 from the windward side to the leeward side. The cylinder bowl is provided with two relatively thick-walled loose flanges which receive bearings 12, 12′ in which the rotor shaft 7 is disposed. Because of an optimal flux of force, the bearing forces are transmitted directly via the gondola wall into the tower wall.

On the windward and leeward sides, the wind power plant has a rotor hub 9 and 9′. The rotor blades 8 and 8′ are shown only as a blade connection. If only one rotor hub is connected, unlike the exemplary embodiment, then the rotor shaft ends after the opposite bearing. The power transmission from the rotor shaft 7 to the generators 15′ disposed at a vertical distance is achieved via an active connection 14, which is shown only diagrammatically.

### Reference list:

1 Connecting point for the tower (2)

2 Tower

3 Tower longitudinal axis

4 Bearing in the top area of the tower (2)

5 Gondola

6 Axis of rotation of the rotor shaft (7)

7 Rotor shaft

8 Rotor blades (8, 8′)

9 Rotor hub (9, 9′)

10 Carrying structure

11 Functional unit comprising the gondola (5) and the carrying structure (10)

12 Bearings (12, 12′) for positioning the rotor shaft (7)

13 Bearing or support element between tower and carrying structure

14 Active connection

15 Generator (15, 15′)

As various changes could be made in the above constructions without departing from the scope of the invention, it is intended that all matter contained in the above description or shown in the accompanying drawings shall be interpreted as illustrative and not in a limiting sense.

1. A wind power plant comprising a tower (2) rigged at a fastening point (1), a gondola (5) rotatably mounted on the tower with a bearing (4) to enable the gondola to rotate about a tower longitudinal axis (3); a rotor shaft (7) mounted in the gondola to rotate about an axis of rotation (6); rotor blades (8) mounted to at least one of a windward or leeward side of the rotor shaft where wind forces act on the rotor shaft (7) for converting the flow energy of the wind into mechanical energy via a rotor hub (9), characterized in that a carrying structure (10) disposed on the underside of the gondola (5) extends inside the tower (2) vertically relative to the fastening point (1) and is connected with the gondola (5) in rotation-proof and torsion-proof manner to form a functional unit (11) with the gondola; the carrying structure (10) carrying components for converting the mechanical energy into a different form of energy; that the rotor shaft (7) extending from the windward side to the leeward side; and the gondola (5) being provided with bearings (12, 12′) on the windward and the leeward sides and in which the shaft (7) is positioned.

2. The wind power plant as defined in claim 1, characterized in that the gondola (5) includes a second rotor hub (9′) carrying a plurality of rotor blades (8′) opposite the first rotor hub (9); the rotor blades (8, 8′) on the windward side and leeward side are at such an angular position to each other relative to the rotating direction of the axis of rotation (6) that they transfer the flow energy of the wind optimally to the rotor hubs (9, 9′) on the windward side and leeward side.

3. The wind power plant as defined in claim 1, characterized in that the functional unit (11) in the area of the carrying structure (10) is rigged to the bearing (4) so as to rotate about the tower longitudinal axis (3).

4. The wind power plant as defined in claim 1, characterized in that a second bearing (4) or a support structure is disposed between the carrying structure (10) and the tower (2).

5. The wind power plant as defined in claim 1, characterized in that the rotor shaft (7) in one or more parts consists of a solid profile and/or a hollow section.

6. The wind power plant as defined in claim 1, characterized in that an active connection (14) bridges the vertical space between the rotor shaft (7) and the components disposed on the carrying structure (10); the active connection (14) comprising components, such as hydraulic units, gearing, shafts or other power transmission elements, which are disposed individually or in combinations.

7. The wind power plant as defined in claim 1, characterized in that the components disposed on the carrying structure (10) are provided with at least one generator (15 or 15′) for converting the mechanical energy into electrical energy.
